(19) United States
(12) Patent Application Publication
(10) Pub. No.: US 2025/0298998 A1
(43) Pub. Date: Sep. 25, 2025

(54) PROVIDING CONTEXTUAL INFORMATION FOR PASSIVE DEVICES

(71) Applicant: QUALCOMM Incorporated, San Diego, CA (US)

(72) Inventors: Paul Dominic HISCOCK, Cambridge (GB); Joseph Patrick BURKE, Carlsbad, CA (US); Sumit AGRAWAL, San Diego, CA (US)

(21) Appl. No.: 19/084,670

(22) Filed: Mar. 19, 2025

Related U.S. Application Data
(60) Provisional application No. 63/567,885, filed on Mar. 20, 2024.

(51) Int. Cl. G06K 7/10

(52) U.S. Cl. CPC G06K 7/10297; G06K 7/10138

(57) ABSTRACT

Techniques are described for wireless communications. For example, a device can transmit, to passive devices, a transmit signal with a first phase. The device can receive, from each passive device, a respective response signal based on the transmit signal and determine, based on a difference between the first phase and a respective phase of each respective response signal, distances for the passive devices. The device can determine a respective confidence level for each respective distance of each passive device to the device based on a variance of the respective phase of each respective response signal. The device can compare the respective distance of each passive device with each other distance to determine a passive device with a smallest distance. The device can output contextual information based on the passive devices first having the smallest distance, with a confidence level determined for a distance from the passive device to the device.

### CROSS-REFERENCE TO RELATED APPLICATIONS

This application is a continuation of U.S. Patent Application 63/567,885, filed Mar. 20, 2024, which is hereby incorporated by referenced in its entirety and for all purposes.

### FIELD

The present disclosure generally relates to wireless communications. For example, aspects of the present disclosure relate to providing contextual information about a closest passive device, such as a Radio Frequency Identification (RFID) tag or similar tag function.

### BACKGROUND

Short range wireless communication enables wireless communication over relatively short distances (e.g., within thirty meters). For example, RFID systems can be used to perform short range wireless communication based on the wireless transfer of data between a reader (e.g., an RFID reader device) and a tag or transponder (e.g., an RFID tag). RFID systems can be used for identification, tracking, data storage, etc. For example, RFID systems can be used to identify and/or track various items, such as warehouse boxes or consumer products.

A RFID tag may be attached to an item to be tracked and may include data storage and an antenna. The data storage can store information corresponding to the associated item, such as a product name, a serial number, product information, a manufacturer, etc. The antenna can enable the RFID tag to be read by an RFID reader, which can transmit an interrogating signal to one or more RFID tags within communication range. RFID tags can be passive, active, semi-passive or semi-active. Passive RFID tags can utilize the interrogating signal from an RFID reader to power a transmission by or from the RFID tag. Active, semi-passive and semi-active RFID tags can include a power source or battery, which can be used to power a transmission by or from the RFID tag.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for providing contextual information about a closest passive device, such as an RFID tag. According to at least one example, a wireless communication device is provided for wireless communications. The wireless communication device includes at least one memory and at least one processor coupled to the at least one memory and configured to: output, for transmission to a plurality of passive devices, a transmit signal with a first phase; receive, from each passive device of the plurality of passive devices, a respective response signal based on the transmit signal, wherein each respective response signal has a respective phase; determine, based on a difference between the first phase and the respective phase of each respective response signal, a plurality of distances for the plurality of passive devices, the plurality of distances comprising a respective distance from each passive device of the plurality of passive devices to the wireless communication device; determine a respective confidence level for the respective distance of each passive device of the plurality of passive devices to the wireless communication device based on a variance of the respective phase of each respective response signal; compare the respective distance of each passive device of the plurality of passive devices with each other distance of the plurality of distances to determine a passive device of the plurality of passive devices with a smallest distance to the wireless communication device; and output information associated with the passive device based on the passive device having the smallest distance to the wireless communication device and based on a confidence level determined for a distance from the passive device to the wireless communication device.

In another illustrative example, a method is provided for wireless communications. The method includes: transmitting, to a plurality of passive devices, a transmit signal with a first phase; receiving, from each passive device of the plurality of passive devices, a respective response signal based on the transmit signal, wherein each respective response signal has a respective phase; determining, based on a difference between the first phase and the respective phase of each respective response signal, a plurality of distances for the plurality of passive devices, the plurality of distances comprising a respective distance from each passive device of the plurality of passive devices to the wireless communication device; determining a respective confidence level for the respective distance of each passive device of the plurality of passive devices to the wireless communication device based on a variance of the respective phase of each respective response signal; comparing the respective distance of each passive device of the plurality of passive devices with each other distance of the plurality of distances to determine a passive device of the plurality of passive devices with a smallest distance to the wireless communication device; and outputting information associated with the passive device based on the passive device having the smallest distance to the wireless communication device and based on a confidence level determined for a distance from the passive device to the wireless communication device.

In another illustrative example, a non-transitory computer-readable medium of a wireless communication device is provided having stored thereon instructions that, when executed by one or more processors, cause the one or more processors to: output, for transmission to a plurality of passive devices, a transmit signal with a first phase; receive, from each passive device of the plurality of passive devices, a respective response signal based on the transmit signal, wherein each respective response signal has a respective phase; determine, based on a difference between the first phase and the respective phase of each respective response signal, a plurality of distances for the plurality of passive devices, the plurality of distances comprising a respective distance from each passive device of the plurality of passive devices to the wireless communication device; determine a respective confidence level for the respective distance of each passive device of the plurality of passive devices to the wireless communication device based on a variance of the respective phase of each respective response signal; compare the respective distance of each passive device of the plurality of passive devices with each other distance of the plurality of distances to determine a passive device of the plurality of passive devices with a smallest distance to the wireless communication device; and output information associated with the passive device based on the passive device having the smallest distance to the wireless communication device and based on a confidence level determined for a distance from the passive device to the wireless communication device.

In another illustrative example, a wireless communication device is provided. The wireless communication device includes: means for transmitting, to a plurality of passive devices, a transmit signal with a first phase; means for receiving, from each passive device of the plurality of passive devices, a respective response signal based on the transmit signal, wherein each respective response signal has a respective phase; means for determining, based on a difference between the first phase and the respective phase of each respective response signal, a plurality of distances for the plurality of passive devices, the plurality of distances comprising a respective distance from each passive device of the plurality of passive devices to the wireless communication device; means for determining a respective confidence level for the respective distance of each passive device of the plurality of passive devices to the wireless communication device based on a variance of the respective phase of each respective response signal; means for comparing the respective distance of each passive device of the plurality of passive devices with each other distance of the plurality of distances to determine a passive device of the plurality of passive devices with a smallest distance to the wireless communication device; and means for outputting information associated with the passive device based on the passive device having the smallest distance to the wireless communication device and based on a confidence level determined for a distance from the passive device to the wireless communication device.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with some examples;

FIG. 2 is a diagram illustrating example components of a device, in accordance with some examples.

FIG. 3 is a diagram illustrating an example of an RFID system, in accordance with some examples.

FIG. 4A is a diagram illustrating an example of an RFID system that can be used for phase-based ranging (PBR) and/or PBR-based distance estimation, in accordance with some examples.

FIG. 4B is a diagram illustrating an example of PBR-based distance estimation using a plurality of RFID phase measurements, in accordance with some examples.

FIG. 5 is a diagram illustrating an example of a system for providing contextual information about a closest passive device, such as an RFID tag, in accordance with some examples.

FIG. 6 is a diagram illustrating an example of information associated with a passive device being displayed on the wireless communication device of FIG. 5, where the information is associated with an item associated with the passive device, in accordance with some examples.

FIG. 7 is a diagram illustrating an example of information associated with a passive device being displayed on the wireless communication device of FIG. 5, where the information includes an indication for a user of the wireless communication device, in accordance with some examples.

FIG. 8 is a flow diagram illustrating an example of a process for wireless communications, in accordance with some examples.

FIG. 9 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Radio Frequency Identification (RFID) systems can be used for short range wireless communication between a reader device (e.g., RFID reader) and one or more tags or transponders (e.g., RFID tags). An RFID reader may also be referred to as a “RFID interrogator,” and “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, a RFID reader (e.g., energizer) can be used to interrogate one or more RFID tags to obtain information of the nearby items that are within communication range of the RFID reader and the interrogation signal. The RFID reader (e.g., energizer) can transmit a radio frequency (RF) signal to perform the energizing and interrogating of the RFID tags. An RFID tag that receives the interrogating RF wave can respond by backscattering (or reflecting back) or transmitting another RF wave. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag).

In some examples (e.g., such as in product-related and/or service-related industries, etc.), RFID systems can be used to track objects that are being processed, inventoried, shipped, handled, etc. For example, an RFID tag can be attached to an individual item (e.g., to the packaging of an individual item, etc.) to provide tracking and identification of the individual item. In some examples, an RFID tag can be attached to a collection or group of individual items (e.g., to a pallet of same or similar items being shipped to a store or distribution center, etc.). In one or more examples, RFID systems can be used in a retail environment for purposes such as inventory tracking (e.g., determining when items are removed from shelves, which particular items are removed from shelves and the quantity thereof, etc.).

An RFID tag attached to a respective item, or attached to a group of items, may store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product Stock Keeping Units (SKUs), etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader, and can use the identification information to determine the tagged items or products that are nearby to the RFID reader.

In some examples, RFID tags can store item identification information that utilizes various granularity levels for tracking and management of the RFID tagged items. For example, RFID tags can be used to track item types or models by using different RFID tags (e.g., unique identifiers) per item type or item model, with RFID identifier reuse across individual tagged items that are of the same type or model. For instance, the RFID tags used for each item of a particular type may store the same product identifier, and can be used to decrement an inventory count for the particular item whenever a tag is scanned and removed from the shelf, from the store, etc.

In another example, RFID tags can be used to track and identify individual items, based on using a corresponding RFID tag and unique identifier for each individual item of a plurality of RFID-tagged items that are registered with the RFID system. In some examples, individual and unique item identifiers can be implemented based on using individual and unique RFID tag serial numbers or identifiers, which may be mapped separately to a corresponding individual item. In some examples, individual and unique item identifiers can be implemented based on using a product type identifier combined with a unique identifier within that product type. For instance, items can be tagged with their corresponding product SKU and a unique identifier of each item within the corresponding product SKU. In some cases, the unique RFID tag identifiers can be mapped in one or more databases to additional information associated with an item, such as manufacturing data, batch number, specific store location, etc.

In some aspects, selective RFID tag reading can be performed based on measuring the respective signal strength of reply transmissions received by an RFID reader from nearby RFID tags (e.g., the nearby RFID tags receiving an energizing or interrogation signal from the RFID reader). In one illustrative example, the systems and techniques can be configured to determine a respective Received Signal Strength Indicator (RSSI) value for each reflected signal received from an RFID tag (e.g., passive RFID tag) in response to an energizing signal used by the RFID reader to interrogate and scan nearby tags. The RSSI value can be indicative of the power level of the reflected signal received by an antenna of the RFID reader, where a larger RSSI value corresponds to a stronger reflected signal. In some cases, RFID ranging or distance estimation between the RFID reader and a plurality of RFID tags can be implemented based on the respective RSSI value determined for the reflected signal(s) from each RFID tag, where a larger RSSI value is associated with a shorter distance between the RFID reader and the corresponding RFID tag. In some cases, the RFID reader (e.g., energizer) can be configured as a smartphone or UE (e.g., of the shopper), etc.

The location accuracy of RSSI-based location or ranging estimates can be relatively low, for example on the order of five to ten meters of accuracy. In a retail environment (or other densely populated RFID environment), a five to ten meter location and ranging accuracy can be insufficient to perform reliable and accurate inventory estimation for RFID tagged items. For example, a five to ten meter location and ranging accuracy may be insufficient for locating items of the surrounding shelves of RFID tagged products or items that fall within the radius of error or uncertainty associated with the RSSI-based ranging estimate.

In the context of retail stores or warehouses, where RFID tags are attached to many items or shelves housing items, and where there is a desire to isolate a single RFID tag to obtain contextual information about an item associated with that RFID tag, there is a need to measure distances between each of the RFID tags and the RFID reader more accurately (e.g., to be able to isolate that RFID tag from other RFID tags). Measuring these distances with accuracy typically may not always be achieved by using standard RSSI techniques as the measurements are generally less accurate (e.g., due to the low location accuracy of RSSI-based ranging estimates) and often ambiguous. As such, improved systems and techniques for providing contextual information about a single passive device (e.g., RFID tag) can be beneficial.

Systems, apparatuses, processes (also referred to as methods), and computer-readable media (collectively referred to as “systems and techniques”) are described herein that can provide contextual information about a closest passive device, such as an RFID tag. In one or more aspects, the systems and techniques preferably employ phase-based ranging (PBR) and/or PBR-based distance estimation to isolate a single passive device (e.g., RFID tag) amongst a plurality of passive devices (e.g., RFID tags). The use of PBR and/or PBR-based distance estimation allows for the distances between each of the passive devices and an RFID reader (e.g., a wireless communication device, such as in the form of a mobile phone that includes an RFID reader) to be measured with sufficient accuracy such that a specific passive device (e.g., an RFID tag) can be isolated from a plurality of passive devices (e.g., by identifying the shortest distance measured). In another aspect, the systems and techniques can employ RSSI based ranging or distance estimation to isolate a single passive device (e.g., RFID tag) amongst a plurality of passive devices (e.g., RFID tags).

In one or more examples, during operation of the systems and techniques, a wireless communication device (e.g., a computing device, such as a mobile device, for example a mobile phone, including an RFID reader) can measure the distances from the wireless communication device to each passive device (e.g., RFID tag) of a plurality of passive devices (e.g., RFID tags) located within radio range (e.g., radio frequency communications range) of the wireless communication device by using PBR and/or PBR-based distance estimation. In some examples, the wireless communication device can determine a confidence metric (e.g., a confidence level) for each of these distance measurements. In one or more examples, the confidence metric can be derived from a variance of the measured phase, after removing a best fit line, made over multiple frequencies used for making each ranging estimate (e.g., distance estimate). The variance can be a measure of multipath, which can indicate that the measured distance is suspicious (e.g., likely inaccurate).

In one or more examples, during operation of the systems and techniques, a wireless communication device (e.g., a computing device, such as a mobile device, for example a mobile phone, including an RFID reader) can measure the distances from the wireless communication device to each passive device (e.g., RFID tag) of a plurality of passive devices (e.g., RFID tags) located within radio range (e.g., radio frequency communications range) of the wireless communication device by using RSSI-based distance estimation. In one illustrative example, the systems and techniques can be configured to determine a respective RSSI value for each reflected signal received from an RFID tag (e.g., passive RFID tag) in response to an energizing signal used by the RFID reader to interrogate and scan nearby tags. The RSSI value can be indicative of the power level of the reflected signal received by an antenna of the RFID reader, where a larger RSSI value corresponds to a stronger reflected signal. In some cases, RFID ranging or distance estimation between the RFID reader and a plurality of RFID tags can be implemented based on the respective RSSI value determined for the reflected signal(s) from each RFID tag, where a larger RSSI value is associated with a shorter distance between the RFID reader and the corresponding RFID tag. In some examples, the wireless communication device can determine a confidence metric (e.g., a confidence level) for each of these distance measurements. In one or more examples, the confidence metric can be derived from a variance of the measured RSSI, after removing a best fit line, made over single or multiple frequencies used for making each ranging estimate (e.g., distance estimate). In some cases, the variance can be a measure of multipath, which can indicate that the measured distance is suspicious (e.g., likely inaccurate).

In one or more examples, the wireless communication device can determine the shortest distance of the measured distances. If the shortest distance also has a high confidence metric (e.g., a high confidence level), then the wireless communication device can select the passive device (e.g., RFID tag) associated with the shortest distance and can report information associated with the selected passive device (e.g., associated with one or more items associated with the selected passive device) to a user of the wireless communication device. In one or more examples, the wireless communication device can report the information to the user by displaying the information on a display (e.g., a display screen) of the wireless communication device. In some examples, the information may include data for one or more items associated with the selected passive device and/or user configurable data for the one or more items associated with the selected passive device. In one or more examples, the data for the one or more items may include, but is not limited to, discounts, sales offers, product information, ingredient information, size information, price information, and/or identification information (e.g., a SKU number) for the one or more items. In some examples, the user configurable data can include, but is not limited to, allergy information associated with the one or more items, which may be food items, associated with the selected passive device.

Conversely, if the shortest distance has a low confidence metric (e.g., a low confidence level), then the wireless communication device can inform or instruct the user of the wireless communication device to move the wireless communication device closer to the selected passive device (e.g., RFID tag). In one or more examples, the wireless communication device can inform or instruct the user by displaying the instructions on a display (e.g., a display screen) of the wireless communication device. After the user has moved the wireless communication device closer to the selected passive device, the wireless communication device can repeat the previously mentioned steps until the shortest distance has a high confidence metric (e.g., a high confidence level). In one or more examples, the performance (e.g., accuracy of the location estimation of the selected passive device) can be improved by combining the confidence metric with the shortest distance along with historical data, as the wireless communication device is being moved by the user towards the selected passive device.

Additional aspects of the present disclosure are described in more detail below.

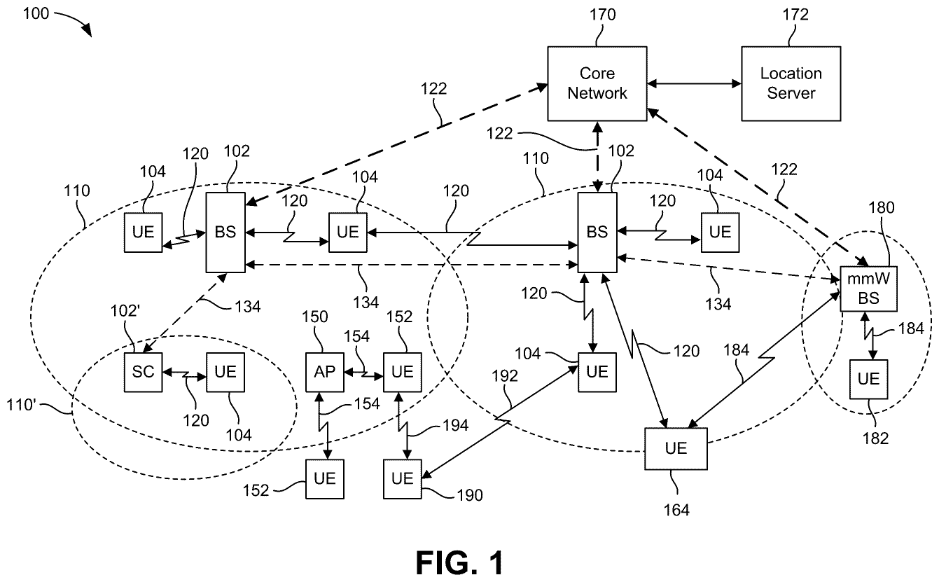

According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

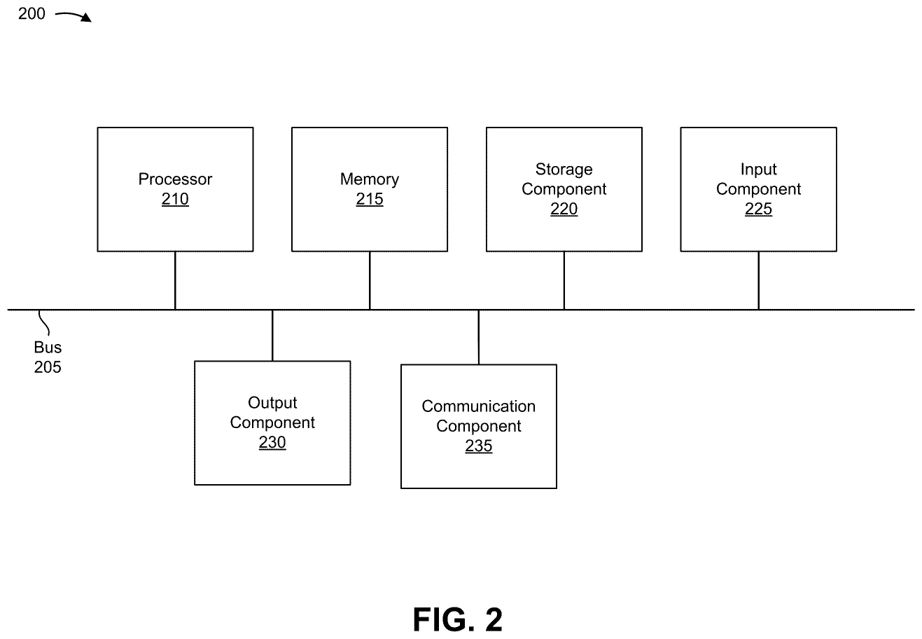

FIG. 2 is a diagram illustrating example components of a device 200, in accordance with the present disclosure. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD). In some aspects, the ESL may be in the form of an RFID tag.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

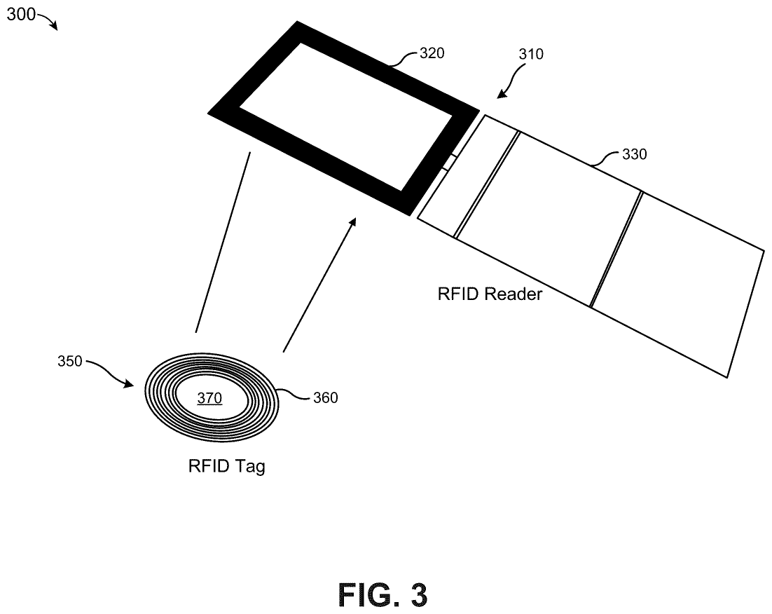

FIG. 3 is a diagram illustrating an example RFID system 300 that includes an RFID reader (e.g., energizer) 310 and an RFID tag 350 (e.g., a passive device). RFID reader 310 (e.g., a wireless communication device) may also be referred to as an interrogator, a scanner, an energizer, etc. RFID tag 350 may also be referred to as an RFID label, an electronics label, etc.

RFID reader 310 includes an antenna 320 and an electronics unit 330. Antenna 320 radiates signals transmitted by RFID reader 310 and receives signals from RFID tags (e.g., such as the RFID tag 350) and/or other devices. Electronics unit 330 may include a transmitter and a receiver for reading RFID tags such as RFID tag 350. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags and the same RFID device can include a receiver for receiving the reflected signals from the one or more RFID tags. In additional, second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by RFID reader 310.

RFID tag 350 includes an antenna 360 and a data storage element 370. Antenna 360 radiates signals transmitted by RFID tag 350 and receives signals from RFID reader 310 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 350 may be a passive RFID tag having no battery. In this case, a magnetic field from a signal transmitted by RFID reader 310 (e.g., an energizing or interrogating signal from the RFID reader 310) may induce an electrical current in RFID tag 350, which may then operate based on the induced current. RFID tag 350 can radiate its signal in response to receiving a signal from RFID reader 310 or some other device.

The RFID tag 350 can use the data storage element 370 to store identification information corresponding to the RFID tag 350 and/or corresponding to an item associated with the RFID tag 350 (e.g., an item to which the RFID tag 350 is attached, etc.). For example, data storage element 370 can be used to store identification information using various granularity levels for tracking and management of an RFID tagged item. An RFID tag attached to a respective item, or attached to a group of items, may store corresponding information thereof. For example, the RFID tag 350 can be configured to store, using data storage element 370, identification information corresponding to the item(s) to which the RFID tag 350 is attached and associated. For instance, RFID tag information can include one or more of a product name, a serial number, product information, a manufacturer, etc. In some examples, the RFID tag 350 can store (e.g., using the data storage element 370) identification information that is directly indicative of a tagged item, product, object, etc. For instance, the RFID tag 350 can store identification information such as a unique product serial number, etc. In some examples, the RFID tag 350 does not store product or item identification information directly, and stores a unique RFID tag serial number or identification number corresponding to the RFID tag 350, which may be externally mapped to various item identification information such as product serial numbers, product names, product SKUs, etc.

Data storage element 370 can be configured to store identification information for RFID tag 350, e.g., in an electrically erasable programmable read-only memory (EEPROM). RFID tag 350 may also include an electronics unit that can process the received signal and generate the signals to be transmitted.

RFID tag 350 may be read as follows. RFID reader 310 may be placed or moved within close proximity to RFID tag 350. RFID reader 310 may radiate a first signal (which is also called an interrogation signal) via its antenna 320. The energy of the first signal may be coupled from RFID reader antenna 320 to RFID tag antenna 360 via magnetic coupling and/or other phenomena. RFID tag 350 may receive the first signal from RFID reader 310 via antenna 360 and, in response, may radiate a second signal (which is also referred to as a responding signal) comprising the information stored in data storage element 370. RFID reader 310 may receive the second signal from RFID tag 350 via antenna 320 and may process the received signal to obtain the information sent in the second signal.

RFID system 300 may be designed to operate at various frequencies and/or frequency ranges. For example, RFID system 300 can operate at 900 MHz, within a range of 860-960 MHz, etc., among various other example frequencies and/or frequency ranges of RFID operations. RFID reader 310 may have a specified maximum transmit power level, which may be imposed by the Federal Communication Commission (FCC) in the United Stated or other regulatory bodies in other countries. The specified maximum transmit power level of RFID reader 310 limits the distance at which RFID tag 350 can be read by RFID reader 310.

As noted previously, the systems and techniques provide contextual information about a closest passive device, such as an RFID tag. In one or more aspects, the systems and techniques employ phase-based ranging (PBR) and/or PBR-based distance estimation to isolate a single passive device (e.g., RFID tag) amongst a plurality of passive devices (e.g., RFID tags). The use of PBR and/or PBR-based distance estimation allows for the distances between each of the passive devices and an RFID reader (e.g., a wireless communication device, such as in the form of a mobile phone that includes an RFID reader) to be measured with sufficient accuracy such that a specific passive device (e.g., an RFID tag) can be isolated from a plurality of passive devices (e.g., by identifying the shortest distance measured). In another aspect, the systems and techniques employ RSSI based distance estimation to isolate a single passive device (e.g., RFID tag) amongst a plurality of passive devices (e.g., RFID tags).

In some aspects, RFID measurements can be performed with a plurality of RFID tags (e.g., RFID tags attached to items or shelves housing corresponding items). The RFID measurements can include phase-based ranging (PBR) measurements, Received Signal Strength Indicator (RSSI) measurements, and/or various combinations thereof.

PBR measurements can be performed between an RFID reader device and an RFID tag, where the RFID reader device is configured to transmit an energizing or interrogating signal and the RFID tag is configured to reflect the interrogating signal as a backscatter signal (e.g., also referred to as a “reflected signal,” “reply signal,” and/or “response signal”).

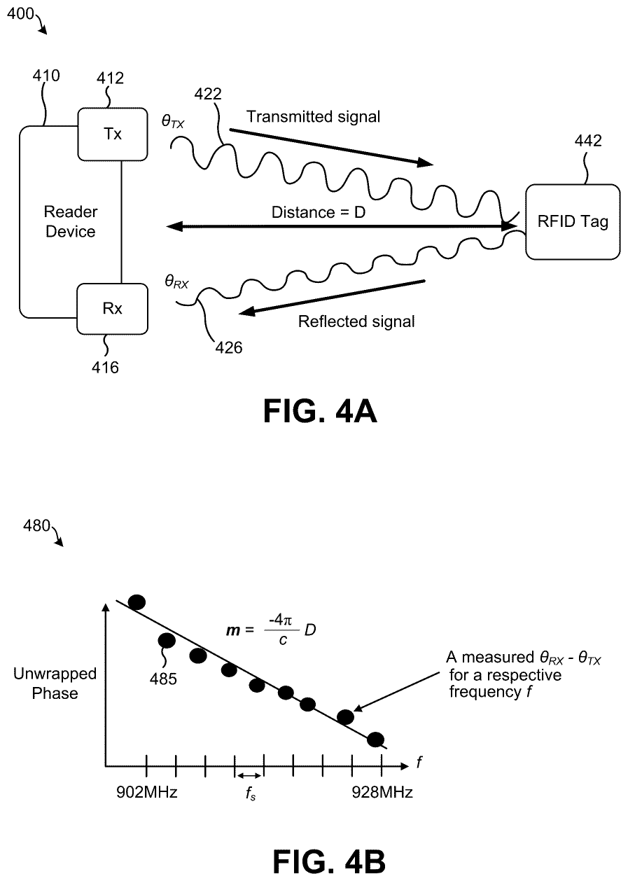

For example, FIG. 4A is a diagram illustrating an example of an RFID system 400 that can be used for phase-based ranging (PBR) and/or PBR-based distance estimation, in accordance with some examples. An RFID reader device 410 (e.g., a wireless communication device, such as in the form of a mobile phone) can include a transmitter (Tx) 412 and a receiver (Rx) 416, configured to transmit and receive RF signals, respectively. The RFID reader device 410 can use the transmitter 412 to transmit a transmitted signal 422 to an RFID tag 442 (e.g., a passive device). The transmitted signal 422 may be associated with a transmitted phase θ_{TX}. In some cases, the transmitted signal 422 may be a modulated signal, or may be an unmodulated signal (e.g., a carrier signal).

The transmitted signal 422, with phase θ_{TX}, propagates a distance D between the reader device 410 and the RFID tag 442, where the distance D is the separation distance or range between the reader device 410 and the RFID tag 442 (e.g., and where the distance D is relatively small such that propagation time does not have a significant effect on the measurement(s)). The RFID tag 442 can be a backscatter RFID tag configured to backscatter (e.g., reflect) an incident signal. For example, the RFID tag 442 can backscatter (e.g., reflect) the transmitted signal 422 as a reflected signal 426 (e.g., response signal). The reflected signal 426 can be associated with a phase θ_{RX} that may be different from the transmitted phase θ_{TX}. The reflected signal 426 is transmitted back to the RFID reader device 410, and is received by the receiver 416 of the RFID reader device 410, with the phase θ_{RX}. In some examples, the reflected signal 426 is weaker (e.g., lower power) than the transmitted signal 422. In some examples, the reader device 410 may generate the transmitted signal as a 900 megahertz (MHz) signal with phase θ_{TX}, among various other frequencies.

In one illustrative example, the RFID reader device 410 can perform phase-based ranging (PBR) measurements based on determining a phase difference between the transmitted signal 422 and the reflected signal 426. For example, a PBR measurement can correspond to the phase difference θ_{RX}-θ_{TX} between the transmitted signal 422 and reflected signal 426 (respectively) at the RFID reader device 410. In some aspects, the RFID reader device 410 determines the phase difference θ_{RX}-θ_{TX} based on removing the relatively strong transmitted signal 422 from the relatively weak reflected signal 426, which may introduce a source of phase error to both the phase difference measurement and the PBR measurement.

In some aspects, the carrier phase may change based on propagation distance at carrier frequency f_{c}, and distance D can be determined as:

$$D ≅ \frac{1}{2} \cdot \frac{{θ}_{R X} - {θ}_{T X}}{2 π} \cdot \frac{c}{{f}_{c}} \qquad Eq . ( 1 )$$

In some examples, a fixed calibration may be needed to account for antennas and reflection in the particular RFID tag 442.

For a carrier frequency of f_{c}=900 MHZ, PBR performed according to Eq. (1) may be associated with a maximum range (e.g., a maximum value of D) of

$$\frac{λ}{2} = 33 cm ,$$

which in some cases may be too small to perform basket content item inventory and/or other RFID PBR measurement implementations (e.g., which may be performed and/or correspond to longer distances and/or ranges).

In some cases, a plurality of PBR measurements can be performed between the RFID reader device 410 and each RFID tag 442 that is of interest or within range of the transmitted signal 422. In one illustrative example, a plurality of transmitted signals 422 can be generated and transmitted by the RFID reader device 410, where each transmitted signal uses a different frequency. A phase difference measurement can be determined for each pair of transmitted signal at a particular frequency and the corresponding reflected signal.

For example, FIG. 4B is a diagram illustrating a plot 480 of PBR-based distance estimation using a plurality of RFID phase difference measurements 485 (also referred to as phase difference measurements), in accordance with some examples. For example, each RFID phase difference measurement 485 can be a phase difference measurement, such as the phase difference measurement θ_{RX}-θ_{TX} between the transmitted signal 422 and reflected signal 426 of FIG. 4A for a particular frequency f_{c}. In some aspects, each RFID phase difference measurement 485 can be a phase difference measured between a transmitted and reflected signal at a different carrier frequency f_{c} of the transmitted signal. Each RFID phase difference measurement 485 of the plurality of RFID phase measurements 485 of FIG. 4B can correspond to signals between an RFID reader and particular RFID tag, such as the RFID reader device 410 and RFID tag 442 of FIG. 4A. In some cases, each RFID phase difference measurement 485 can be determined for a frequency f_{c} that is a configured offset fₛ away from the adjacent RFID phase difference measurement 485 (e.g., phase difference measurement) made at (f_{c}+fₛ) and (f_{c}−fₛ).

In one illustrative example, PBR measurements can be performed to obtain the plurality of RFID phase difference measurements 485 using a plurality of different transmitted signal carrier frequencies f_{c} for the transmitted signal 422 from the RFID reader device 410 of FIG. 4A. A PBR-based distance estimate can be determined based on the gradient (e.g., slope) of a best-fit line determined for the plurality of phase difference measurements 485. For example, the gradient m can be determined as:

$$m = \frac{- 4 π}{c} D \qquad Eq . ( 2 )$$

Here, D represents the PBR-based distance estimate between the RFID reader device 410 and the RFID tag 442.

In some examples, a variance of the estimated distance D can be determined as σ_{D}², where σ_{D}² is based on the gradient-error equation of the best-fit line for the gradient m, the phase noise variance σ_{ϵ}², the frequency spacing fₛ, and the number of uniformly-spaced samples N in the plurality of phase difference measurements 485:

$${σ}_{D}^{2} = \frac{3 {σ}_{ϵ}^{2} {c}^{2}}{4 {π}^{2} {f}_{s}^{2} ( {N}^{3} - N )} \qquad Eq . ( 3 )$$

The term de represents the total phase noise, which can comprise principal components: σ_{ϵ}²=σ_{ϵG}²+σ_{ϵV}².

For example, σ_{ϵV}² can represent the phase noise variance due to the VCO oscillator, and may be a function of the reader radio (e.g., the RFID reader device 410 radio, such as Rx 416 and/or Tx 412) and any additional phase noise introduced by the tag (e.g., the RFID tag 442) and the signal cancellation.

The term σ_{ϵG}², can represent the phase noise variance based on Gaussian noise. For example, for SNR_{dB} 10>dB, the Gaussian noise (e.g., SNR) can create an approximate phase noise σ_{ϵG} according to:

$${σ}_{ϵ G} ≅ \sqrt{\frac{1}{2 \cdot SNR}} , where SNR = {10}^{\frac{S N {R}_{d B}}{10}} \qquad Eq . ( 4 )$$

In some aspects, based on averaging multiple samples N (e.g., multiple phase difference measurements, such as the plurality of phase difference measurements 485 of FIG. 4B), the Gaussian phase noise σ_{ϵG} of Eq. (4) can be reduced. Reducing the Gaussian phase noise σ_{ϵG} can reduce the variance of the PBR-based distance estimate D, with the variance given according to Eq. (3).

For example, in some aspects, PBR distance estimation can be performed based on analyzing the phase change in an RF carrier, where the phase change in the RF carrier is based on the distance between two radio antennas. The phase change of the RF carrier can be analyzed to measure and/or determine range. In one illustrative example, multiple phase measurements (e.g., phase difference measurements 485 of FIG. 4B) can be obtained, each at different respective carrier frequencies f_{c}.

The gradient, m, of a best-fit line through the unwrapped phases, against carrier frequency f_{c}, can be used as a good approximation to the distance D between the radios (e.g., between the RFID reader device 410 and the RFID tag 442 of FIG. 4A). For example, in the context of RFID, PBR distance estimation can be used to determine the distance (e.g., range) between an RFID reader device and a particular RFID tag. A single phase change can be measured by the RFID reader device, for example on a single carrier, by transmitting an RF carrier, with the RFID tag configured to backscatter the carrier modulated with a modulated tone (e.g., 1010101010, etc.). For instance, transmitting an RF carrier can correspond to the transmitted signal 422 transmitted by the RFID reader device 410 of FIG. 4A. The RFID tag backscattering the carrier modulated with a modulated tone can correspond to the reflected signal 426 from the RFID tag 442 of FIG. 4A.

For example, in RFID RAIN (e.g., Radio Frequency Identification Recognize, Action, Interact, Network), the transmitted signal 422 and reflected signal 426 can be implemented based on an RFID tag (e.g., the RFID tag 442 of FIG. 4A) responding to a Query command (e.g., transmitted by the RFID reader device 410 of FIG. 4A). In some aspects, the RFID reader device 410 (e.g., and Rx 416 thereof) can measure a single phase-difference from the modulated tone signal on either side of the DC carrier, to obtain an individual phase difference measurement 485 for a corresponding carrier frequency f_{c}.

The distance estimate D can be determined based on multiple phase difference measurements 485, as noted above. In some cases, multiple commands can be transmitted from the RFID reader device 410 to the RFID tag 442 (e.g., multiple Query transmissions). In some cases, a separate Query command (e.g., a separate transmitted signal 422) can be used for each phase difference measurement 485 at a corresponding carrier frequency f_{c}. In some aspects, the RFID reader device 410 can be configured to change the carrier frequency f_{c} of the transmitted signal 422 during the reading back of the modulated tone of the reflected signal 426 from the RFID tag 442. For instance, in examples where the RFID tag 442 is a passive RFID tag, the RFID tag 442 is not aware of the change in carrier frequency f_{c} and will continue to reflect the modulated tone with the newly adjusted RF carrier. In one illustrative example, the RFID reader device 410 can be configured to capture the reflected signal 426 from the RFID tag 442 that is responsive to the changing carrier frequency and/or RF carrier used for the transmitted signal 422. Based on storing information indicative of the respective time(s) when the RFID reader device 410 changed the carrier frequency for the transmitted signal 422, the RFID reader device 410 can be configured to extract or determine the relative phase difference measurement 485 information for each frequency of interest associated with plotting the plurality of phase difference measurements 485 along the horizontal frequency axis of the plot 480 of FIG. 4B. In some aspects, the distance estimate D can be determined using a single message (e.g., transmitted signal 422, Query message with changing RF carrier, etc.) from the RFID reader device 410 to the RFID tag 442.

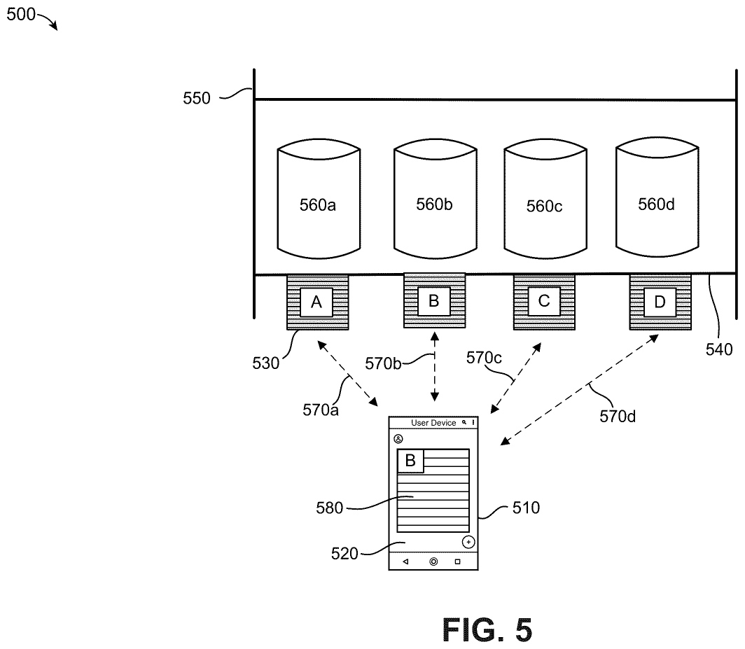

FIGS. 5, 6, and 7 together show an example of operation of the systems and techniques for providing contextual information about a closest passive device, such as an RFID tag. In particular, FIG. 5 is a diagram illustrating an example of a system 500 for providing contextual information 580 about a closest passive device 530, such as an RFID tag. In FIG. 5, the system 500 is shown to include a wireless communication device 510, which is shown to be the form of a mobile device (e.g., a mobile phone). In one or more examples, the wireless communication device may be in the form of other types of mobile devices (e.g., a tablet device) other than a mobile phone, as is shown in FIG. 5. The wireless communication device 510 can include an RFID reader and a display 520 (e.g., a display screen).

The system 500 is also shown to include passive devices 530 (e.g., tag A, tag B, tag C, and tag D, which are each in the form of an RFID tag) mounted onto a shelf 540 of a shelving unit 550, which may be located within a retail store or warehouse. Items 560a, 560b, 560c, 560d (e.g., which may be products, such as soup cans) are shown to be located on the shelf 540 of the shelving unit 550. These items 560a, 560b, 560c, 560c can each be associated with the particular passive device 530 (e.g., tag A, tag B, tag C, and tag D) that is located directly below the items 560a, 560b, 560c, 560c. For example, item 560a can be associated with passive device 530 (e.g., tag A), item 560b can be associated with passive device 530 (e.g., tag B), item 560c can be associated with passive device 530 (e.g., tag C), and item 560d can be associated with passive device 530 (e.g., tag D).

During operation of the system 500 of FIG. 5, the wireless communication device 510 can transmit a transmit signal (e.g., refer to signals 570a, 570b, 570c, 570d) with a first phase (e.g., phase θ_{TX}) and a first frequency (e.g., f_{c}) to the plurality of passive devices 530 (e.g., tag A, tag B, tag C, and tag D). The transmit signal can reflect off the each of the passive devices 530 (e.g., tag A, tag B, tag C, and tag D) to produce respective response signals (e.g., refer to signals 570a, 570b, 570c, 570d) and, as such, the respective response signals are based on the transmit signal. Each respective response signal can have a respective phase (e.g., phase θ_{RXa}, phase θ_{RXb}, phase θ_{RXc}, and phase θ_{RXd}).

The wireless communication device 510 can receive the respective response signals (e.g., refer to signals 570a, 570b, 570c, 570d) reflected from the plurality of passive devices 530 (e.g., tag A, tag B, tag C, and tag D). After the wireless communication device 510 receives the respective response signals, the wireless communication device 510 can determine (e.g., using PBR by using equation 1), based on a difference between the first phase (e.g., phase θ_{TX}) and the respective phase (e.g., phase θ_{RXa}, phase θ_{RXb}, phase θ_{RXc}, and phase θ_{RXd}) of each respective response signal (e.g., refer to signals 570a, 570b, 570c, 570d), a plurality of distances (e.g., D_{A}, D_{B}, D_{C}, and D_{D}) for the plurality of passive devices 530 (e.g., tag A, tag B, tag C, and tag D). In one or more examples, the plurality of distances (e.g., D_{A}, D_{B}, D_{C}, and D_{D}) include a respective distance (e.g., D_{A}) from each passive device 530 (e.g., tag A) of the plurality of passive devices 530 (e.g., tag A, tag B, tag C, and tag D) to the wireless communication device 510.

In one or more examples, the wireless communication device 510 can perform the PRB measurements for obtaining the distances (e.g., D_{A}, D_{B}, D_{C}, and D_{D}) using a plurality of different frequencies (e.g., f_{c}, (f_{c}+fₛ), (f_{c}+2fₛ), (f_{c}+3fₛ) . . . ) for the transmit signal transmitted from the wireless communication device 510. A PRB-based distance estimate can be determined by the wireless communication device 510 based on the gradient (e.g., slope m of best-fit line of FIG. 4B) of a best-fit line determined for the plurality of phase difference measurements (e.g., phase difference measurements 485 on FIG. 4B). In one or more examples, the wireless communication device 510 can determine (e.g., by using equation 3) a variance (e.g., σ_{D}²) of the respective phase of each respective response signal (e.g., a variance of the measured phase, after removing a best-fit line, made over multiple frequencies).

The wireless communication device 510 can determine a respective confidence level for the respective distance (e.g., D_{A}, D_{B}, D_{C}, and D_{D}) of each passive device 530 of the plurality of passive devices 530 (e.g., tag A, tag B, tag C, and tag D) to the wireless communication device 510, based on the variance of the respective phase of each respective response signal (e.g., refer to signals 570a, 570b, 570c, 570d). The wireless communication device 510 can then compare the respective distance (e.g., D_{A}, D_{B}, D_{C}, and D_{D}) of each passive device of the plurality of passive devices 530 (e.g., tag A, tag B, tag C, and tag D) with each other distance of the plurality of distances to determine a passive device 530 (e.g., tag B) of the plurality of passive devices with a smallest distance (e.g., D_{B}) to the wireless communication device 510. For example, in FIG. 5, the distance D_{B} is shown to be smaller than distances D_{A}, D_{C}, and D_{D}. Since the passive device 530 (e.g., tag B) is shown to have the smallest distance (e.g., D_{B}) to the wireless communication device 510, the passive device 530 (e.g., tag B) is located the closest to the wireless communication device 510.

In one or more examples, the wireless communication device 510 can output information 580 associated with the passive device 530 (e.g., tag B) based on the passive device 530 (e.g., tag B) having the smallest distance (e.g., D_{B}) to the wireless communication device 510 and based on a confidence level determined for a distance (e.g., D_{B}) from the passive device 530 (e.g., tag B) to the wireless communication device 510.

In some examples, outputting (e.g., by the wireless communication device 510) the information 580 associated with the passive device 530 (e.g., tag B) involves outputting device information for the passive device 530 (e.g., tag B) based on the confidence level determined for the distance (e.g., D_{B}) of the passive device 530 (e.g., tag B) being greater than a confidence threshold and the passive device 530 (e.g., tag B) having the smallest distance (e.g., D_{B}) to the wireless communication device 510. In one or more examples, the wireless communication device 510 can compare the confidence level determined for the distance (e.g., D_{B}) of the passive device 530 (e.g., tag B) with the confidence threshold to determine whether the confidence level is greater than the confidence threshold. In some examples, the confidence threshold can be a predetermined value, such as 0.7, 0.8. 0.9, or some other value.

In one or more examples, outputting the device information can involve displaying the device information via the display 520 of the wireless communication device. In some examples, the device information can include data for one or more items (e.g., item 560b) associated with the passive device 530 (e.g., tag B) or user configurable data for the one or more items (e.g., item 560b) associated with the passive device 530 (e.g., tag B). In one or more examples, the data for the one or more items (e.g., item 560b) may include, but is not limited to, discounts, sales offers, product information, ingredient information, size information, price information, and/or identification information (e.g., a SKU number) for the one or more items (e.g., item 560b). In one or more examples, the user configurable data may be allergy information associated with the one or more items (e.g., item 560b), which may be food items. In some examples, the user of the wireless communication device 510 may configure, via the wireless communication device 510, the user configurable data for the one or more items (e.g., item 560b).

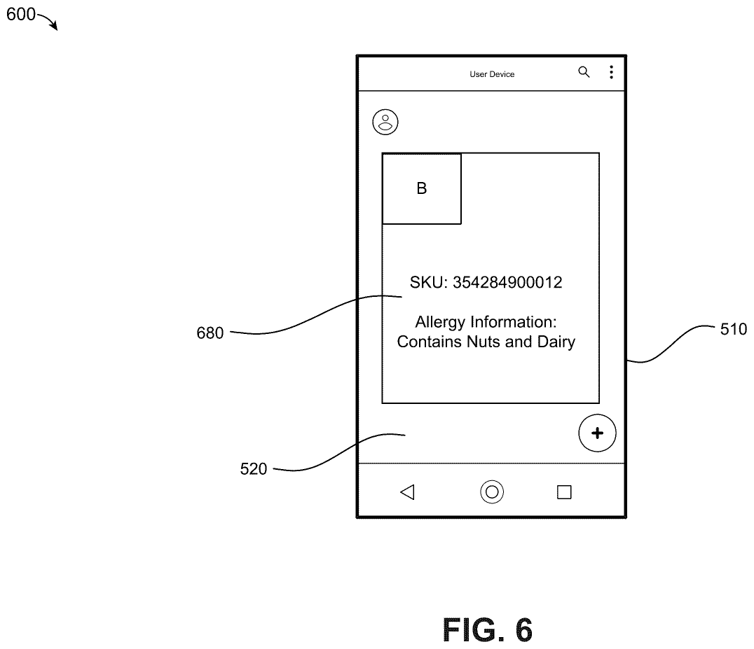

FIG. 6 is a diagram 600 illustrating an example of information associated with one or more items associated with a passive device (e.g., an RFID tag) being displayed on a wireless communication device. In particular, FIG. 6 is a diagram illustrating an example of information 680 associated with the passive device 530 (e.g., tag B) being displayed on the display 520 of the wireless communication device 510, where the information 680 is associated with an item (e.g., item 560b) associated with the passive device 530 (e.g., tag B). In FIG. 6, the display 520 of the wireless communication device 510 is displaying a SKU number associated with the item 560b and allergy information associated with the item 560b indicating that the item 560b contains nuts and dairy.

In one or more examples, outputting (e.g., by the wireless communication device 510) the information associated with the passive device 530 (e.g., tag B) can involve outputting an indication to the user of the wireless communication device 510 to move the wireless communication device 510 closer to the passive device 530 (e.g., tag B) based on the confidence level determined for the distance (e.g., D_{B}) of the passive device 530 (e.g., tag B) being less than a confidence threshold (e.g., a confidence threshold level). In one or more examples, the wireless communication device 510 can compare the confidence level determined for the distance (e.g., D_{B}) of the passive device 530 (e.g., tag B) with the confidence threshold to determine whether the confidence level is less than the confidence threshold.

In some examples, providing (e.g., by the wireless communication device 510) the indication can involve displaying the indication via the display 520 of the wireless communication device 510. After the user has moved the wireless communication device 510 closer to the passive device 530 (e.g., tag B), the wireless communication device 510 can repeat the previously mentioned steps until the shortest distance (e.g., D_{B}) has a high confidence level. In one or more examples, as the wireless communication device 510 is moved closer to the passive device 530 (e.g., tag B), the wireless communication device 510 can combine historical data with the confidence level determined for the distance (e.g., D_{B}) of the passive device 530 (e.g., tag B).

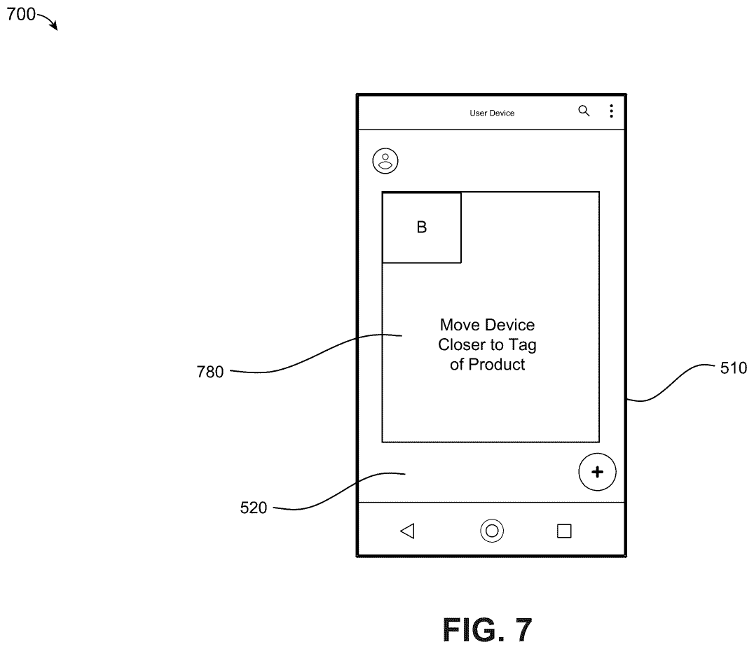

FIG. 7 is a diagram 700 illustrating an example of information associated with a passive device (e.g., an RFID tag) being displayed on a wireless communication device. In particular, FIG. 7 is a diagram illustrating an example of information 780 associated with a passive device 530 (e.g., tag B) being displayed on the wireless communication device 510, where the information 780 includes an indication for a user of the wireless communication device 510. In FIG. 7, the display 520 of the wireless communication device 510 is displaying an indication or instructions to the user to move the device (e.g., the wireless communication device 510) closer to the tag (e.g., the passive device 530 (e.g., tag B)) of the product (item 560b). In one or more examples, the indication or instructions for the user to move the device closer to the tag of the product may include instructions regarding how the user should move the device. In some examples, the instructions may specify a distance (e.g., two inches closer), a direction (left, right, up, or down), an angle (a forty-five degree angle towards the right), and/or some other descriptor for how the user should move the device (e.g., wireless communication device 510) towards the tag (e.g., passive device 530 (e.g., tag B)).

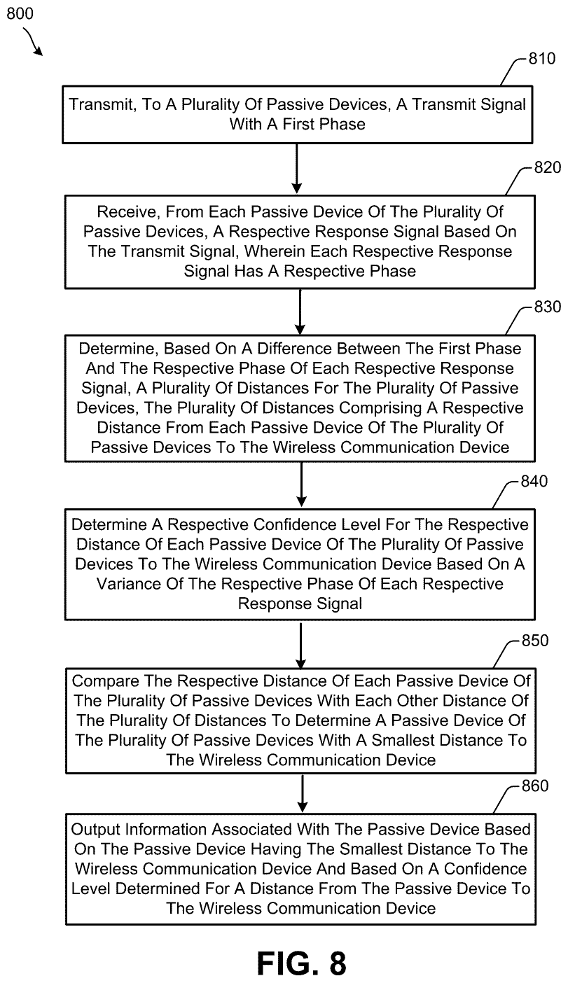

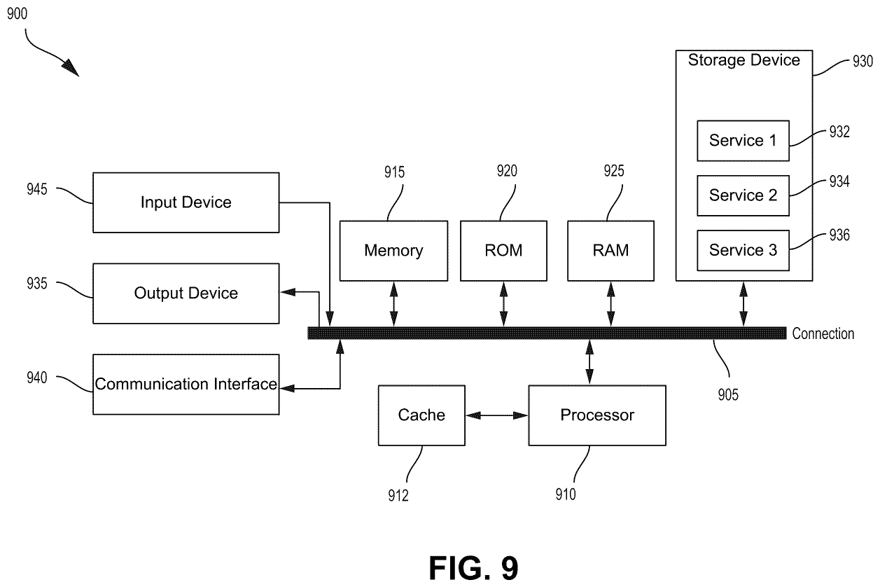

FIG. 8 is a flowchart diagram illustrating an example of a process 800 for wireless communications. In some examples, the process 800 can be performed by a wireless communication device (e.g., a mobile device) or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the wireless communication device. The operations of the process 800 may be implemented as software components that are executed and run on one or more processors (e.g., processor 910 of FIG. 9 or other processor(s)). In some examples, the wireless communication device can include an RFID reader and/or RFID energizer, for example the RFID reader 310 of FIG. 3, the RFID reader device 410 of FIG. 4A, the wireless communication device 510 of FIGS. 5, 6, and 7, etc. In some aspects, the process 800 can be performed by a UE, smartphone, mobile computing device, user computer device, etc., that includes and/or implements an RFID reader (e.g., RFID energizer). In some examples, the process 800 can be performed by a computing device that includes an SoC configured to implement and/or including an RFID reader (e.g., RFID energizer). In some cases, the process 800 can be performed by an RFID reader (e.g., RFID energizer) included in or associated with a mobile device, such as a mobile phone.

At block 810, the computing device (or component thereof) can transmit (or output for transmission), to a plurality of passive devices, a transmit signal with a first phase. In some aspects, each passive device of the plurality of passive devices is a radio frequency identification (RFID) tag.

At block 820, the computing device (or component thereof) can receive, from each passive device of the plurality of passive devices, a respective response signal based on the transmit signal. Each respective response signal has a respective phase.

At block 830, the computing device (or component thereof) can determine, based on a difference between the first phase and the respective phase of each respective response signal, a plurality of distances for the plurality of passive devices. The plurality of distances include a respective distance from each passive device of the plurality of passive devices to the wireless communication device.

At block 840, the computing device (or component thereof) can determine a respective confidence level for the respective distance of each passive device of the plurality of passive devices to the wireless communication device based on a variance of the respective phase of each respective response signal.

At block 850, the computing device (or component thereof) can compare the respective distance of each passive device of the plurality of passive devices with each other distance of the plurality of distances to determine a passive device of the plurality of passive devices with a smallest distance to the wireless communication device.

At block 860, the computing device (or component thereof) can output information (e.g., selectively output) associated with the passive device based on the passive device having the smallest distance to the wireless communication device and based on a confidence level determined for a distance from the passive device to the wireless communication device. In some cases, to output the information associated with the passive device, the computing device (or component thereof) can output device information for the passive device based on the confidence level determined for the distance of the passive device being greater than a confidence threshold and the passive device having the smallest distance to the wireless communication device. In some aspects, to output the device information, the computing device (or component thereof) can display the device information (or output the device information for display) via a display of the wireless communication device. The device information can include data for one or more items associated with the passive device, user configurable data for the one or more items associated with the passive device, and/or other information. For instance, the user configurable data can include allergy information associated with the one or more items.

In some cases, to output the information associated with the passive device, the computing device (or component thereof) output an indication to move the wireless communication device closer to the passive device based on the confidence level determined for the distance of the passive device being less than a confidence threshold. In some examples, outputting the indication includes displaying the indication via a display of the wireless communication device.

In some aspects, the computing device (or component thereof) can combine, as the wireless communication device is moved closer to the passive device, historical data with the confidence level determined for the distance of the passive device.

The computing device (e.g., wireless communication device) may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a computing device configured to perform the process 800 of FIG. 8 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed by the disclosed systems and techniques. In particular, FIG. 9 illustrates an example of computing system 900, which can be, for example, any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random-access memory (RAM) 925 to processor 910. Computing system 900 can include a cache 912 of high-speed memory connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LIDAR sensors, laser range finders, RF radars, ultrasonic sensors, and infrared (IR) sensors) configured to collect data and provide measurements to processor 910, whereby processor 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

### Illustrative Aspects of the Disclosure Include:

Aspect 1. A wireless communication device for wireless communications, the wireless communication device comprising: at least one memory; and at least one processor coupled to the at least one memory and configured to: output, for transmission to a plurality of passive devices, a transmit signal with a first phase; receive, from each passive device of the plurality of passive devices, a respective response signal based on the transmit signal, wherein each respective response signal has a respective phase; determine, based on a difference between the first phase and the respective phase of each respective response signal, a plurality of distances for the plurality of passive devices, the plurality of distances comprising a respective distance from each passive device of the plurality of passive devices to the wireless communication device; determine a respective confidence level for the respective distance of each passive device of the plurality of passive devices to the wireless communication device based on a variance of the respective phase of each respective response signal; compare the respective distance of each passive device of the plurality of passive devices with each other distance of the plurality of distances to determine a passive device of the plurality of passive devices with a smallest distance to the wireless communication device; and output information associated with the passive device based on the passive device having the smallest distance to the wireless communication device and based on a confidence level determined for a distance from the passive device to the wireless communication device.

Aspect 2. The wireless communication device of Aspect 1, wherein, to output the information associated with the passive device, the at least one processor is configured to output device information for the passive device based on the confidence level determined for the distance of the passive device being greater than a confidence threshold and the passive device having the smallest distance to the wireless communication device.

Aspect 3. The wireless communication device of Aspect 2, wherein, to output the device information, the at least one processor is configured to output the device information for display via a display of the wireless communication device.

Aspect 4. The wireless communication device of any of Aspects 2 or 3, wherein the device information comprises at least one of data for one or more items associated with the passive device or user configurable data for the one or more items associated with the passive device.

Aspect 5. The wireless communication device of Aspect 4, wherein the user configurable data is allergy information associated with the one or more items.

Aspect 6. The wireless communication device of any of Aspects 1 to 5, wherein, to output the information associated with the passive device, the at least one processor is configured to output an indication to move the wireless communication device closer to the passive device based on the confidence level determined for the distance of the passive device being less than a confidence threshold.

Aspect 7. The wireless communication device of Aspect 6, wherein, to output the indication, the at least one processor is configured to output the indication for display via a display of the wireless communication device.

Aspect 8. The wireless communication device of any of Aspects 6 or 7, wherein the at least one processor is configured to combine, as the wireless communication device is moved closer to the passive device, historical data with the confidence level determined for the distance of the passive device.

Aspect 9. The wireless communication device of any of Aspects 1 to 8, wherein each passive device of the plurality of passive devices is a radio frequency identification (RFID) tag.

Aspect 10. The wireless communication device of any of Aspects 1 to 9, wherein the wireless communication device is a mobile device.

Aspect 11. The wireless communication device of any of Aspects 1 to 10, wherein the at least one processor is configured to automatically select output information associated with the passive device based on the passive device having the smallest distance to the wireless communication device and based on the confidence level determined for the distance from the passive device to the wireless communication device.

Aspect 12. A method for wireless communications performed at a wireless communication device, the method comprising: transmitting, to a plurality of passive devices, a transmit signal with a first phase; receiving, from each passive device of the plurality of passive devices, a respective response signal based on the transmit signal, wherein each respective response signal has a respective phase; determining, based on a difference between the first phase and the respective phase of each respective response signal, a plurality of distances for the plurality of passive devices, the plurality of distances comprising a respective distance from each passive device of the plurality of passive devices to the wireless communication device; determining a respective confidence level for the respective distance of each passive device of the plurality of passive devices to the wireless communication device based on a variance of the respective phase of each respective response signal; comparing the respective distance of each passive device of the plurality of passive devices with each other distance of the plurality of distances to determine a passive device of the plurality of passive devices with a smallest distance to the wireless communication device; and outputting information associated with the passive device based on the passive device having the smallest distance to the wireless communication device and based on a confidence level determined for a distance from the passive device to the wireless communication device.

Aspect 13. The method of Aspect 12, wherein outputting the information associated with the passive device comprises outputting device information for the passive device based on the confidence level determined for the distance of the passive device being greater than a confidence threshold and the passive device having the smallest distance to the wireless communication device.

Aspect 14. The method of Aspect 13, wherein outputting the device information comprises displaying the device information via a display of the wireless communication device.

Aspect 15. The method of any of Aspects 13 or 14, wherein the device information comprises at least one of data for one or more items associated with the passive device or user configurable data for the one or more items associated with the passive device.

Aspect 16. The method of Aspect 15, wherein the user configurable data is allergy information associated with the one or more items.

Aspect 17. The method of any of Aspects 12 to 16, wherein outputting the information associated with the passive device comprises outputting an indication to move the wireless communication device closer to the passive device based on the confidence level determined for the distance of the passive device being less than a confidence threshold.

Aspect 18. The method of Aspect 17, wherein outputting the indication comprises displaying the indication via a display of the wireless communication device.

Aspect 19. The method of any of Aspects 17 or 18, further comprising combining, as the wireless communication device is moved closer to the passive device, historical data with the confidence level determined for the distance of the passive device.

Aspect 20. The method of any of Aspects 12 to 19, wherein each passive device of the plurality of passive devices is a radio frequency identification (RFID) tag.

Aspect 21. The method of any of Aspects 12 to 20, wherein the wireless communication device is a mobile device.

Aspect 22. The method of any of Aspects 12 to 21, further comprising automatically selecting output information associated with the passive device based on the passive device having the smallest distance to the wireless communication device and based on the confidence level determined for the distance from the passive device to the wireless communication device.

Aspect 23. A non-transitory computer-readable medium having stored thereon instructions that, when executed by one or more processors, cause the one or more processors to perform operations according to any of Aspects 12 to 22.

Aspect 24. An apparatus including one or more means for performing operations according to any of Aspects 12 to 22.

Aspect 25. A wireless communication device for wireless communications, the wireless communication device comprising: at least one memory; and at least one processor coupled to the at least one memory and configured to: receive, from each passive device of a plurality of passive devices, a respective signal having a respective received signal strength; determine, based on each respective received signal strength of each respective signal from each passive device, a plurality of distances for the plurality of passive devices, the plurality of distances comprising a respective distance from each passive device of the plurality of passive devices to the wireless communication device; determine a respective confidence level for the respective distance of each passive device of the plurality of passive devices to the wireless communication device based on a variance of the respective received signal strength of each respective signal; compare the respective distance of each passive device of the plurality of passive devices with each other distance of the plurality of distances to determine a passive device of the plurality of passive devices with a smallest distance to the wireless communication device; and output information associated with the passive device based on the passive device having the smallest distance to the wireless communication device and based on a confidence level determined for a distance from the passive device to the wireless communication device.

Aspect 26. A method for wireless communications at a wireless communication device, the method comprising: receiving, from each passive device of a plurality of passive devices, a respective signal having a respective received signal strength; determining, based on each respective received signal strength of each respective signal from each passive device, a plurality of distances for the plurality of passive devices, the plurality of distances comprising a respective distance from each passive device of the plurality of passive devices to the wireless communication device; determining a respective confidence level for the respective distance of each passive device of the plurality of passive devices to the wireless communication device based on a variance of the respective received signal strength of each respective signal; comparing the respective distance of each passive device of the plurality of passive devices with each other distance of the plurality of distances to determine a passive device of the plurality of passive devices with a smallest distance to the wireless communication device; and outputting information associated with the passive device based on the passive device having the smallest distance to the wireless communication device and based on a confidence level determined for a distance from the passive device to the wireless communication device.

Aspect 27. A non-transitory computer-readable medium of a wireless communication device having stored thereon instructions that, when executed by one or more processors, cause the one or more processors to: receive, from each passive device of a plurality of passive devices, a respective signal having a respective received signal strength; determine, based on each respective received signal strength of each respective signal from each passive device, a plurality of distances for the plurality of passive devices, the plurality of distances comprising a respective distance from each passive device of the plurality of passive devices to the wireless communication device; determine a respective confidence level for the respective distance of each passive device of the plurality of passive devices to the wireless communication device based on a variance of the respective received signal strength of each respective signal; compare the respective distance of each passive device of the plurality of passive devices with each other distance of the plurality of distances to determine a passive device of the plurality of passive devices with a smallest distance to the wireless communication device; and output information associated with the passive device based on the passive device having the smallest distance to the wireless communication device and based on a confidence level determined for a distance from the passive device to the wireless communication device.

Aspect 28. A wireless communication device including: means for receiving, from each passive device of a plurality of passive devices, a respective signal having a respective received signal strength; means for determining, based on each respective received signal strength of each respective signal from each passive device, a plurality of distances for the plurality of passive devices, the plurality of distances comprising a respective distance from each passive device of the plurality of passive devices to the wireless communication device; means for determining a respective confidence level for the respective distance of each passive device of the plurality of passive devices to the wireless communication device based on a variance of the respective received signal strength of each respective signal; means for comparing the respective distance of each passive device of the plurality of passive devices with each other distance of the plurality of distances to determine a passive device of the plurality of passive devices with a smallest distance to the wireless communication device; and means for outputting information associated with the passive device based on the passive device having the smallest distance to the wireless communication device and based on a confidence level determined for a distance from the passive device to the wireless communication device.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A wireless communication device for wireless communications, the wireless communication device comprising:
at least one memory; and
at least one processor coupled to the at least one memory and configured to:
output, for transmission to a plurality of passive devices, a transmit signal with a first phase;
receive, from each passive device of the plurality of passive devices, a respective response signal based on the transmit signal, wherein each respective response signal has a respective phase;
determine, based on a difference between the first phase and the respective phase of each respective response signal, a plurality of distances for the plurality of passive devices, the plurality of distances comprising a respective distance from each passive device of the plurality of passive devices to the wireless communication device;
determine a respective confidence level for the respective distance of each passive device of the plurality of passive devices to the wireless communication device based on a variance of the respective phase of each respective response signal;
compare the respective distance of each passive device of the plurality of passive devices with each other distance of the plurality of distances to determine a passive device of the plurality of passive devices with a smallest distance to the wireless communication device; and
output information associated with the passive device based on the passive device having the smallest distance to the wireless communication device and based on a confidence level determined for a distance from the passive device to the wireless communication device.

2. The wireless communication device of claim 1, wherein, to output the information associated with the passive device, the at least one processor is configured to output device information for the passive device based on the confidence level determined for the distance of the passive device being greater than a confidence threshold and the passive device having the smallest distance to the wireless communication device.

3. The wireless communication device of claim 2, wherein, to output the device information, the at least one processor is configured to output the device information for display via a display of the wireless communication device.

4. The wireless communication device of claim 2, wherein the device information comprises at least one of data for one or more items associated with the passive device or user configurable data for the one or more items associated with the passive device.

5. The wireless communication device of claim 4, wherein the user configurable data is allergy information associated with the one or more items.

6. The wireless communication device of claim 1, wherein, to output the information associated with the passive device, the at least one processor is configured to output an indication to move the wireless communication device closer to the passive device based on the confidence level determined for the distance of the passive device being less than a confidence threshold.

7. The wireless communication device of claim 6, wherein, to output the indication, the at least one processor is configured to output the indication for display via a display of the wireless communication device.

8. The wireless communication device of claim 6, wherein the at least one processor is configured to combine, as the wireless communication device is moved closer to the passive device, historical data with the confidence level determined for the distance of the passive device.

9. The wireless communication device of claim 1, wherein each passive device of the plurality of passive devices is a radio frequency identification (RFID) tag.

10. The wireless communication device of claim 1, wherein the wireless communication device is a mobile device.

11. The wireless communication device of claim 1, wherein the at least one processor is configured to automatically select output information associated with the passive device based on the passive device having the smallest distance to the wireless communication device and based on the confidence level determined for the distance from the passive device to the wireless communication device.

12. A method for wireless communications performed at a wireless communication device, the method comprising:
transmitting, to a plurality of passive devices, a transmit signal with a first phase;
receiving, from each passive device of the plurality of passive devices, a respective response signal based on the transmit signal, wherein each respective response signal has a respective phase;
determining, based on a difference between the first phase and the respective phase of each respective response signal, a plurality of distances for the plurality of passive devices, the plurality of distances comprising a respective distance from each passive device of the plurality of passive devices to the wireless communication device;
determining a respective confidence level for the respective distance of each passive device of the plurality of passive devices to the wireless communication device based on a variance of the respective phase of each respective response signal;
comparing the respective distance of each passive device of the plurality of passive devices with each other distance of the plurality of distances to determine a passive device of the plurality of passive devices with a smallest distance to the wireless communication device; and
outputting information associated with the passive device based on the passive device having the smallest distance to the wireless communication device and based on a confidence level determined for a distance from the passive device to the wireless communication device.

13. The method of claim 12, wherein outputting the information associated with the passive device comprises outputting device information for the passive device based on the confidence level determined for the distance of the passive device being greater than a confidence threshold and the passive device having the smallest distance to the wireless communication device.

14. The method of claim 13, wherein outputting the device information comprises displaying the device information via a display of the wireless communication device.

15. The method of claim 13, wherein the device information comprises at least one of data for one or more items associated with the passive device or user configurable data for the one or more items associated with the passive device.

16. The method of claim 15, wherein the user configurable data is allergy information associated with the one or more items.

17. The method of claim 12, wherein outputting the information associated with the passive device comprises outputting an indication to move the wireless communication device closer to the passive device based on the confidence level determined for the distance of the passive device being less than a confidence threshold.

18. The method of claim 17, wherein outputting the indication comprises displaying the indication via a display of the wireless communication device.

19. The method of claim 17, further comprising combining, as the wireless communication device is moved closer to the passive device, historical data with the confidence level determined for the distance of the passive device.

20. The method of claim 12, wherein each passive device of the plurality of passive devices is a radio frequency identification (RFID) tag.
